(19) United States
(12) Patent Application Publication
(10) Pub. No.: US 2005/0028395 A1
(43) Pub. Date: Feb. 10, 2005

(54) Guide clamp

(76) Inventors: Hsu Hsiu-Kwei Liu, Feng Yuan City (TW); Ming-Hsiang Chiu, Chia Yi City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/634,191

(22) Filed: Aug. 4, 2003

(51) Int. Cl. G01D 21/00

(52) U.S. Cl. 33/640

(57) ABSTRACT

An easily releasable guide clamp includes a body, a rod, a stationary jaw, a movable jaw assembly and a cam. The movable jaw assembly includes a movable jaw, several locking plates, a release carrier and a spring. Each of the locking plates includes an upper portion defining an aperture for receiving the rod and a lower portion extending from the upper portion at an angle. The apertures are sized so that the locking plates easily slide on the rod whenever the upper portions thereof are normal to the rod but lock to the rod whenever the upper portions thereof are tipped from the normal position as the upper portions of the locking plates are moved by means of the rod while the lower portions of the locking plates are stopped by means of the movable jaw. The release carrier is movable relative to the movable jaw. The spring is compressed between the movable jaw and the locking plates for returning the upper portions of the locking plates to the normal position. The cam is pivotally connected with the rod for contact with the stationary jaw so that pivotal of the lever and the contact of the cam with the stationary jaw cause movement of the rod along the body.

### FIELD OF INVENTION

The present invention relates to a guide clamp.

### BACKGROUND OF INVENTION

U.S. Pat. No. 4,394,800 discloses a conventional guide clamp G including a bar B, a clamp jaw C secured to the bar B and a shifting jaw S movable along the bar B. The shifting jaw S can be moved towards the clamp jaw C so as to clamp a workpiece W. A rod R and a lever L are used to move the shifting jaw S. The rod R extends through a cavity 22 defined in the bar B. The lever L includes a cam formed at an end. The cam is in pivotal connection with the rod R and in contact with the bar B. Thus, pivotal of the lever L causes the movement of the rod R. The shifting jaw S is attached to the rod R so that the shifting jaw S retains its position relative to or slides along the rod R. The shifting jaw S includes a jaw block 51, a plurality of lock clips 52 and a release carrier 53. The jaw block 51 and the release carrier 53 are both mounted on the rod R in a sliding manner. The lock clips 52 are nested between the jaw bock 51 and the release carrier 53 for unitary function. Each lock clip 52 is bent. That is, each lock clip 52 includes an upper portion and a lower portion. The rod R extends in a hole 60 that is defined in the upper portion of each lock clip 52. The holes 60 are sized so that the lock clips 52 easily slide on the rod R whenever they are normal to the rod R, but lock to the rod R whenever they are tipped from the normal position. Referring to FIG. 9, the movement of the rod R causes the lower portions of the lock clips 52 to abut a jaw abutment 57 of the jaw block 51, thus tipping the lock clips 52 from the normal position. The lock clips 52 therefore lock on the rod R, i.e., thus the shifting jaw S moves, together with the rod R, towards the clamp jaw C so as to clamp the workpiece W. To allow the lock clips 52 to slide on the rod R, the release carrier 53 is moved from the jaw block 51 so that a crossbar 63 of the carrier 53 returns the lock clips 52 to the normal position. However, the locks 52 tend to stick to the tipped position and cause some troubles for an operator to move the shifting jaw S.

The present invention is therefore intended to obviate or at least alleviate the problems encountered in prior art.

### SUMMARY OF INVENTION

It is an objective of the present invention to provide an easily releasable guide clamp.

According to the present invention, an easily releasable guide clamp includes a body, a rod, a stationary jaw, a movable jaw assembly and a cam. The body is for installment on an object. The rod is movable along the body. The stationary jaw is secured to the body for contact with an edge of the object. The movable jaw assembly is movable along the body. The movable jaw assembly includes a movable jaw, several locking plates, a release carrier and a spring. The movable jaw is for contact with an opposite edge of the object. Each of the locking plates includes an upper portion defining an aperture for receiving the rod and a lower portion extending from the upper portion at an angle. The apertures are sized so that the locking plates easily slide on the rod whenever the upper portions thereof are normal to the rod but lock to the rod whenever the upper portions thereof are tipped from the normal position as the upper portions of the locking plates are moved by means of the rod while the lower portions of the locking plates are stopped by means of the movable jaw. The release carrier is movable relative to the movable jaw. The spring is compressed between the movable jaw and the locking plates for returning the upper portions of the locking plates to the normal position. The cam is pivotally connected with the rod for contact with the stationary jaw so that pivotal of the lever and the contact of the cam with the stationary jaw cause movement of the rod along the body.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a front-right-top perspective view of a guide clamp according to a first embodiment of the present invention installed on a table.

FIG. 2 is an enlarged front-right-bottom perspective view of the guide clamp of FIG. 1.

FIG. 3 is an exploded view of the guide clamp of FIG. 2.

FIG. 4 is a cutaway view of the guide clamp of FIG. 2.

FIG. 5 is a cross-sectional view of the guide clamp of FIG. 2.

FIG. 6 is a cross-sectional view of the guide clamp of FIG. 2.

FIG. 7 is similar to FIG. 6 except for showing the guide clamp in a different position.

FIG. 8 is a perspective view of two guide clamps used together, one on the other.

FIG. 9 is a partially explosive view of the guide clamps of FIG. 8.

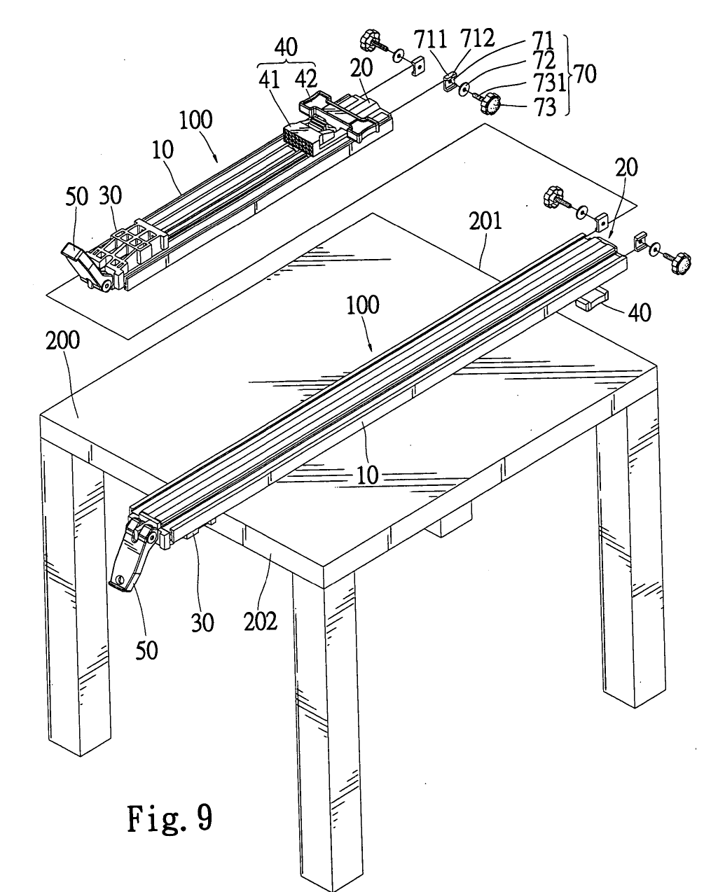

FIG. 10 is a perspective, cross-sectional view of the guide clamps of FIG. 9.

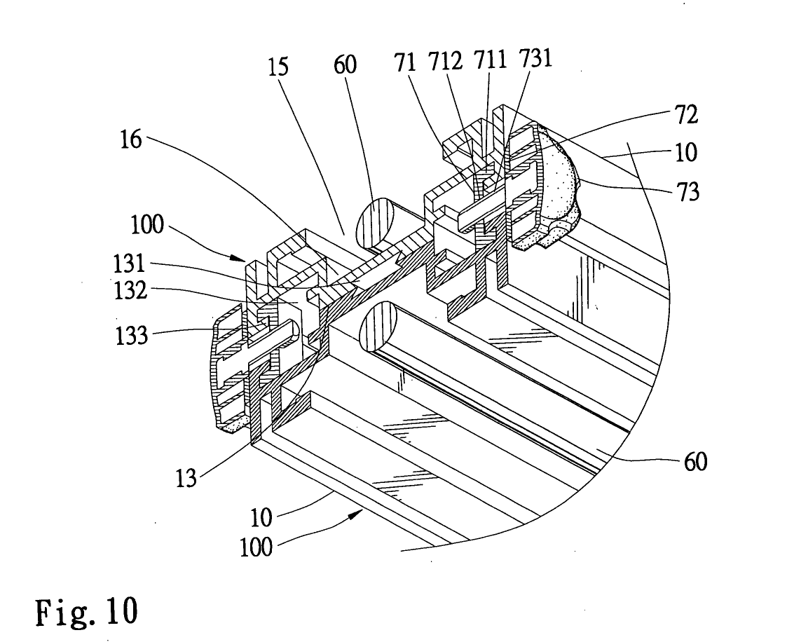

FIG. 11 is a perspective view of a guide clamp according to a second embodiment of the present invention.

FIG. 12 is a partially explosive view of the guide clamp of FIG. 11.

### DETAILED DESCRIPTION OF EMBODIMENTS

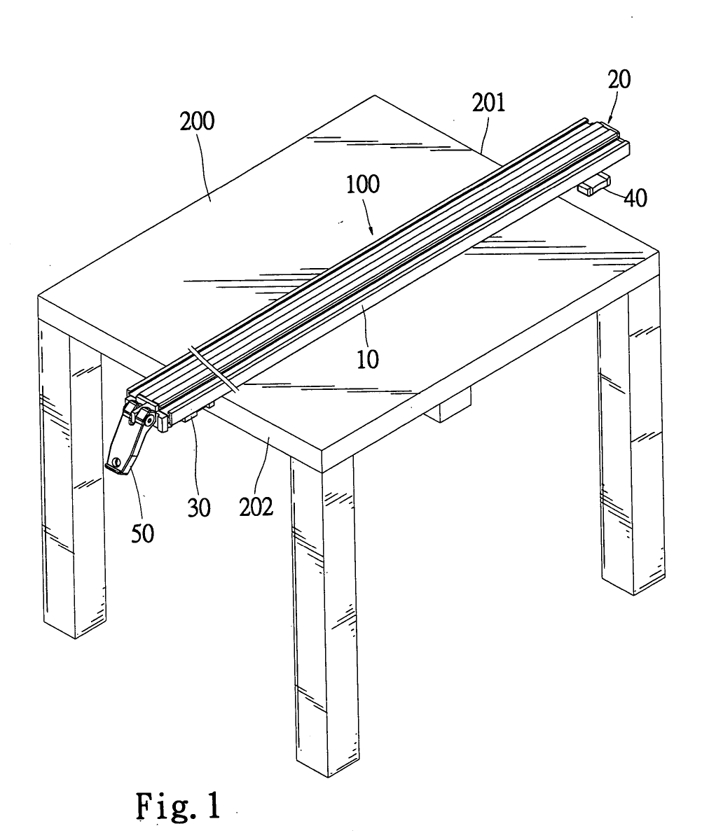

Referring to FIG. 1, a guide clamp 100 according to a first embodiment of the present invention is installed on a table 200. The guide clamp 100 includes a body 10 put on the table 200, a stationary jaw 30 secured to the body 10 for contact with an edge 202 of the table 200, a movable jaw assembly 40 movable along the body 10 for contact with an opposite edge 201 of the table 200 and an end cap 20 secured to the body 10 for keeping the movable jaw assembly 40 to the body 10.

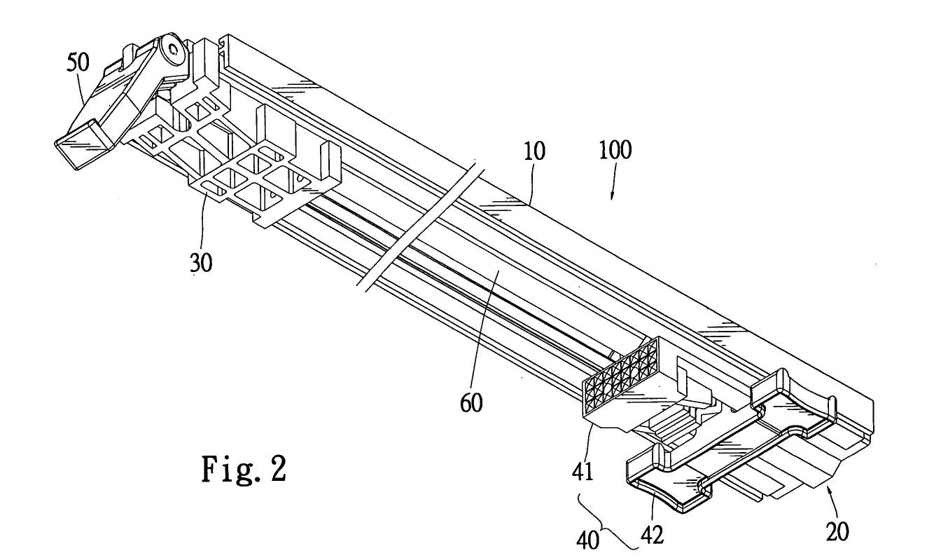

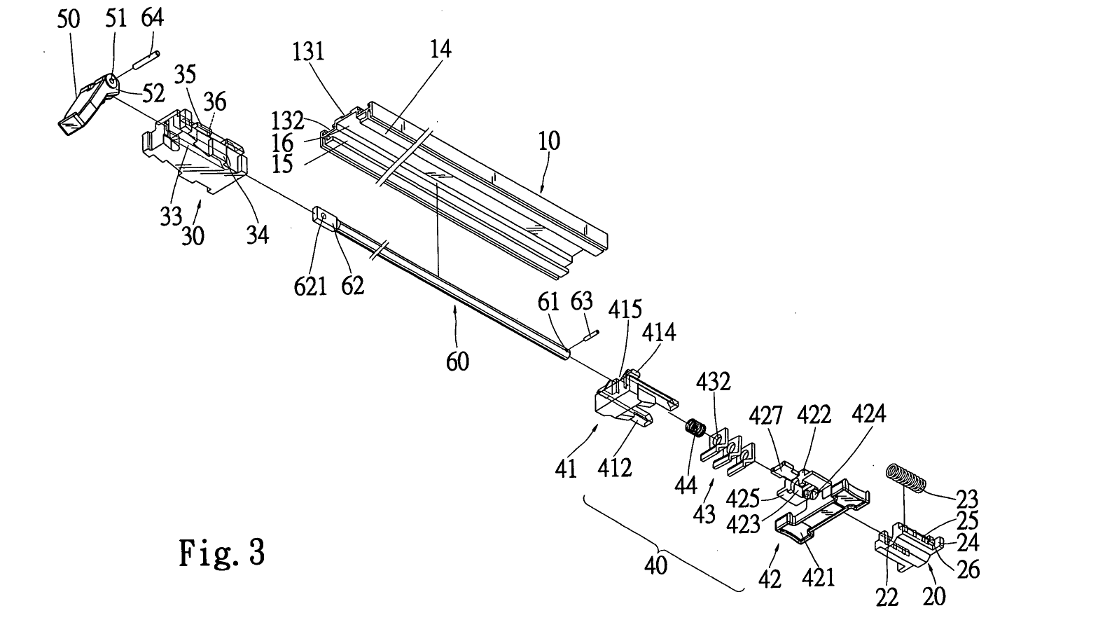

Referring to FIG. 2, the guide clamp 100 further includes a rod 60 movably attached to the body 10 and a lever 50 pivotally connected with the rod 60. At an end of the lever 50 is formed a cam 52 (see FIG. 3) for contact with the stationary jaw 30. Thus, pivotal of the lever 50 and the contact of the cam 52 with the stationary jaw 40 cause movement of the rod 60 along the body 10. The movement of the rod 60 can cause movement of the movable jaw assembly 40 so as to clamp the table 200.

Referring to FIG. 3, the body 10 includes an elongated form with a first end, a second end, a bottom, a top and two walls. The body 10 includes a groove 16 defined in the bottom, two grooves 15 communicated with the groove 16 and two flanges 14 each extending below one of the grooves 15. The grooves 15 and 16 all include two open ends. In the top of the body 10 are defined a dovetail groove 131 and two grooves 132 between which the dovetail groove 131 is located.

The stationary jaw 30 includes a first end, a second end, a bottom, a top and two walls. From each of the walls of the stationary jaw 30 extend at least one protrusion 36 near the top, two fins 35 below the at least one protrusion 36 and two blocks 34 below the fins 35. A tunnel 33 is defined in the stationary jaw 30.

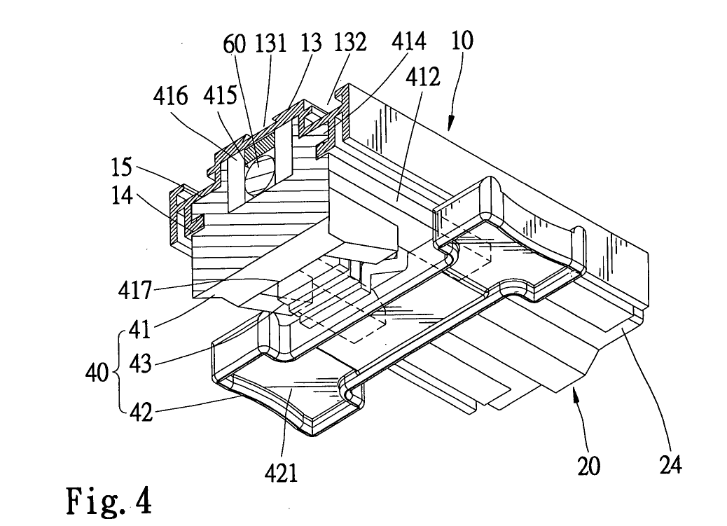

Referring to FIGS. 3 and 4, the movable jaw assembly 40 includes a movable jaw 41, a release carrier 42 connected with the movable jaw 41, a plurality of locking plates 43 located between the movable jaw 41 and the release carrier 42, and a spring 44 compressed between the movable jaw 41 and the locking plates 43.

The movable jaw 41 includes a first end, a second end, a bottom, a top and two walls. The movable jaw 14 includes two beams 412 extending from the second end of the movable jaw 41 and a fin 414 from each of the walls. A recess 415 is defined in the top of the movable jaw 41.

The release carrier 42 includes a handle 421, a slide 422 extending from the handle 421 and a connector 427 extending from the slide 422. The handle 421 defines an aperture 424. The slide 422 defines a recess 423 communicated with the aperture 424. Two wings 425 extend from the slide 422. The connector 427 includes an enlarged end.

Each of the locking plates 43 is a bent plate with a lower portion and an upper portion defining an aperture 432.

To assemble the movable jaw assembly 40, the connector 427 is put in the recess 415. The enlarged end of the connector 427 is on one end of the movable jaw 41 while the slide 422 and the handle 421 are on an opposite end of the movable jaw 41. Thus, the movable jaw 41 and the release carrier 42 are movable relative to but not detachable from each other. The spring 44 and the locking plates 43 are put in the recess 423.

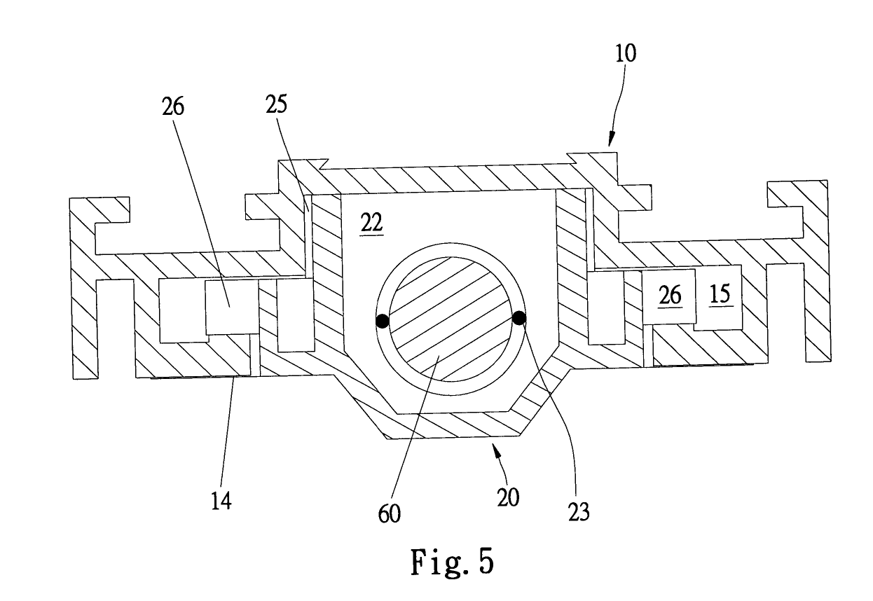

Referring to FIGS. 3 and 5, the end cap 20 includes a first end, a second end, a bottom, a top and two walls. A recess 22 is defined in the top of the end cap 20 in order to receive a spring 23. At least one protrusion 25 is formed on each of the walls of the end cap 20 near the top. A wing 26 extends from each of the walls of the end cap 20 near the bottom.

To attach the stationary jaw 30 to the body 10, the fins 35 are inserted in the grooves 15. The fins 35 are put on the flanges 14. The blocks 34 are located below the flanges 14. The at least one protrusion 36 extending from each of the walls of the stationary jaw 30 is in frictional contact with one of two walls of the groove 16 so as to keep the stationary jaw 30 to the body 10.

To attach the movable jaw assembly 40 to the body 10, the wings 414 and 425 are inserted in the grooves 15. The installment of the locking plates 43 and the spring 44 is to be described.

To attach the end cap 20 to the body 10, the wings 26 are inserted in the grooves 15. The at least one protrusion 25 extending from each of the walls of the end cap 20 is in frictional contact with one of the walls of the groove 16 so as to keep the end cap 20 to the body 10.

The rod 60 is inserted through the recess 22, the aperture 424, the recess 423, the apertures 432 defined in the locking plates 43, a tunnel defined in and by the spring 44 and the tunnel 33. The locking plates 43 and the spring 44 are thus mounted on the rod 60. A pin 63 is inserted in an aperture 61 defined in the rod 60 so as to engage with the spring 23. A pin 64 is inserted in an aperture 51 defined in the cam 52 and an aperture 621 defined in the rod 60 so as to pivotally connect cam 52 (and therefore the lever 50) with the rod 60.

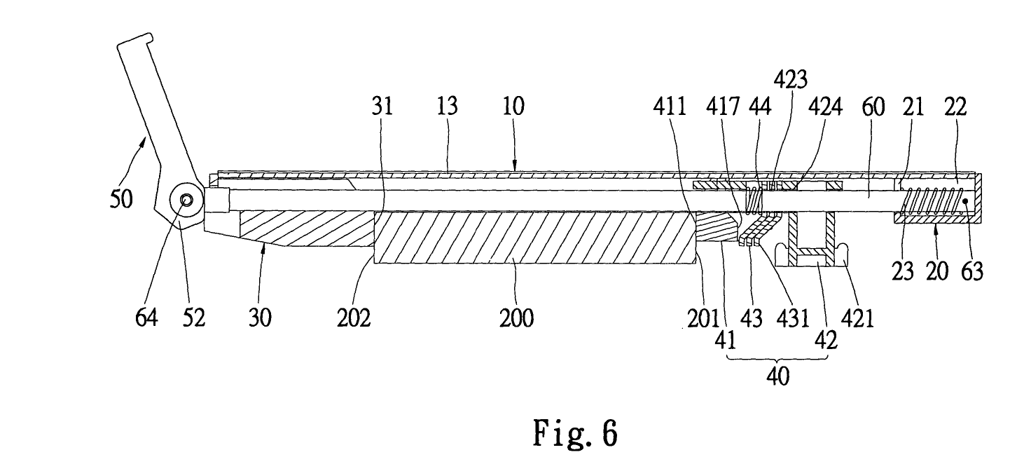

Referring to FIG. 6, the guide clamp 100 is put on a table 200. The lever 50 is in a releasing position. The upper portion of each of the locking plates 43 extends vertically so that the movable jaw assembly 40 is allowed to slide on the rod 60. Just before clamping the table 20, the movable jaw assembly 40 is moved towards the stationary jaw 30 to a position where the movable jaw assembly 40 slightly contacts the edge 201, and the stationary jaw 30 the edge 202.

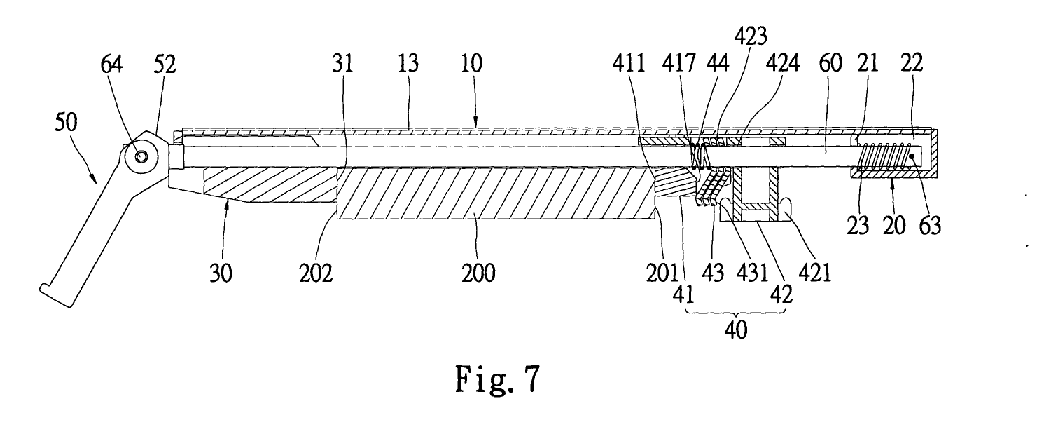

To clamp the table 200, the lever 50 is pivoted to a locking position shown in FIG. 7 from the releasing position of FIG. 6. Because of the cam 52, the rod 60 moves in a first direction to the stationary jaw 30 from the movable jaw assembly 40. The rod 60 carries the upper portion of each of the locking plates 43 while the movable jaw 41 retains the lower portion of each of the locking plates 43. Thus, the locking plates 43 tilt and lock to the rod 60. The movable jaw assembly 40 locks to the rod 60. The rod 60 moves the movable jaw assembly 40 towards the stationary jaw 30. Therefore, the table 200 is clamped by means of the guide clamp 100.

To release the table 200, the lever 50 is pivoted to the releasing position of FIG. 6 from the locking position shown in FIG. 7. Because of the cam 52, the rod 60 moves in a second direction opposite to the first direction. The rod 60 is supposed to make the upper portion of each of the locking plates 43 extend vertically again. Advantageously, the spring 44 pushes and makes the upper portion of each of the locking plates 43 extend vertically again. Thus, the movable jaw assembly 40 can slide on the rod 60 again.

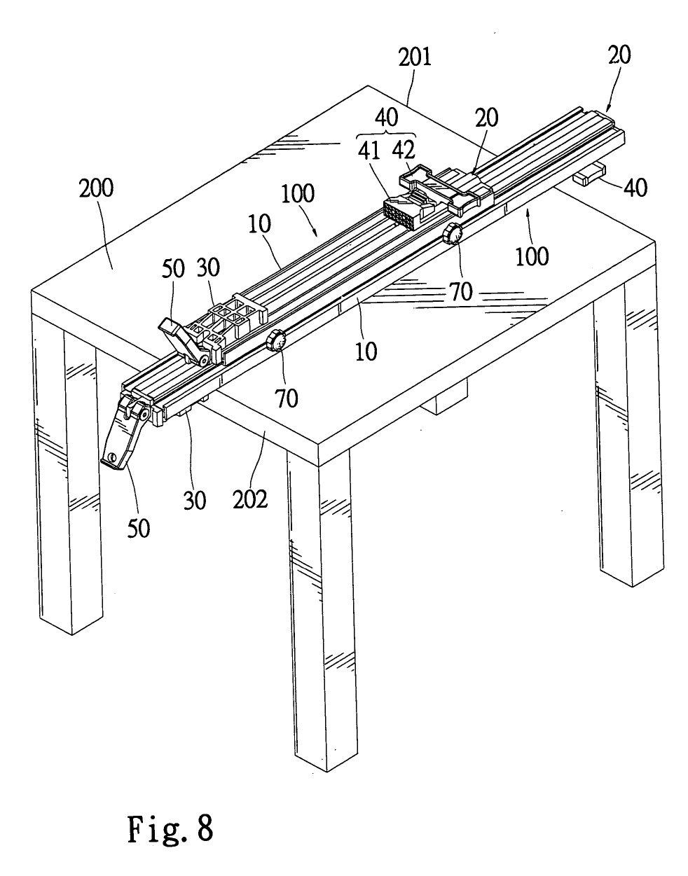

Referring to FIGS. 8˜10, two guide clamps 100 are used. One of the guide clamps (“lower guide clamp”) 100 is installed on the table 200, and the other of the guide clamps (“upper guide clamp”) 100 on the lower guide clamp 100. The lower guide clamp 100 is capable of clamping the table 200. The upper guide clamp 100 is capable of clamping a workpiece (not shown) or tool (not shown).

A plurality of connecting devices 70 is used to join the lower guide clamp 100 with the upper guide clamp 100. Each of the connecting devices 70 includes a connecting plate 71, a washer 72 and a bolt 73.

The connecting plate 71 includes a claw 711 put in one of the grooves 132 of the body 10 of the lower guide clamp 100 and another claw 711 put in one of the grooves 132 of the body 10 of the upper guide clamp 100. The connecting plate 71 defines an aperture 712. The bolt 73 is driven into the aperture 712 through the washer 72.

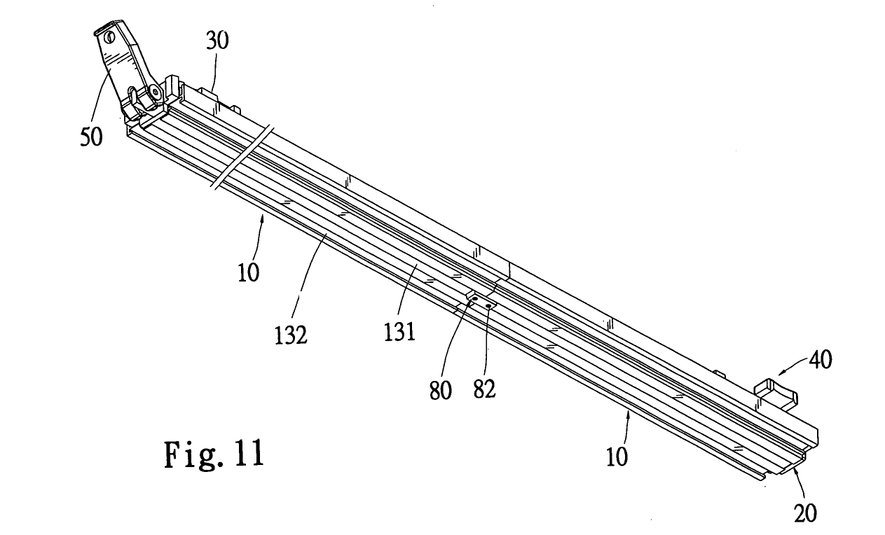

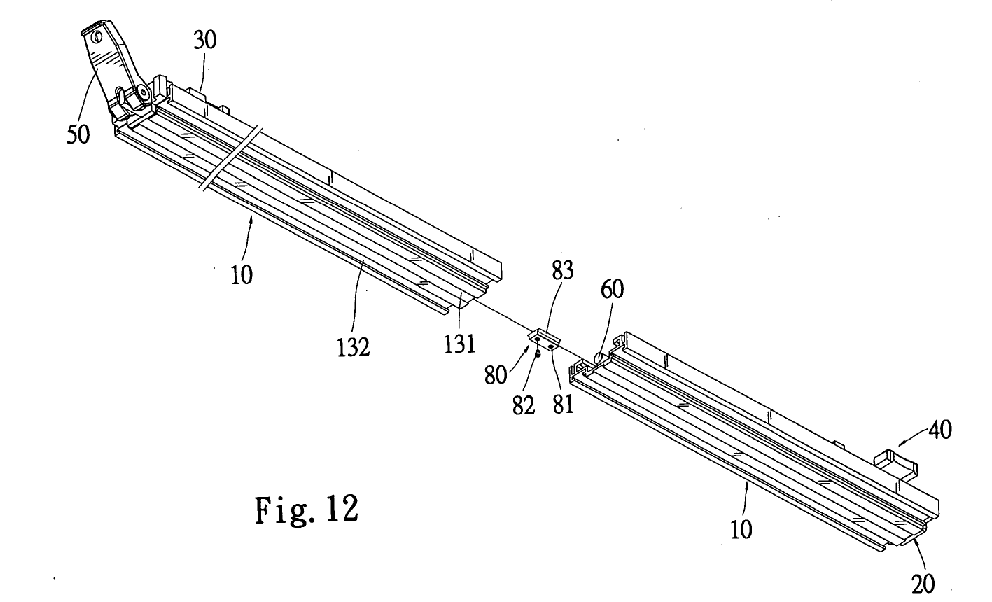

FIGS. 11 and 12 show a guide clamp according to a second embodiment of the present invention. The second embodiment is identical to the first embodiment except for including two bodies 10 instead of one. Two bodies 10 are used in order to enable the guide clamp 100 to clamp a table of a greater than length than that of the table 200.

The bodies 10 are combined with one another by means of a connecting device 80. The connecting device 80 includes a dovetail 83 and two screws 82. The dovetail 83 includes two sections each defining an aperture 81. Each of the sections of the dovetail 83 is inserted in the dovetail groove 131 of one of the bodies 10. A screw 82 is driven into each of the bodies 10 through one of the apertures 81.

The dovetail groove 131 and the grooves 132 are capable of receiving and retaining therein a fastening element such as the dovetail 83, the claw 711, a nut (not shown) and a head of a bolt (not shown). These grooves all include two open ends through which a fastener can be moved, a bottom and a top narrower than the bottom for trapping such a fastening element. A tool (not shown) can be attached to the body 100 by means of such a fastening element. Alternatively, a tool such as a ruler may be directly attached to the body 10 via insertion in the dovetail groove 131, without the use of a fastening element.

The present invention has been described via detailed illustration of some embodiments. Those skilled in the art can derive variations from the embodiments without departing from the scope of the present invention. Therefore, the embodiments shall not limit the scope of the present invention defined in the claims.

1. A guide clamp including:
a body for installment on an object;
a rod movable along the body;
a stationary jaw secured to the body for contact with an edge of the object;
a movable jaw assembly movable along the body, the movable jaw assembly including:
a movable jaw for contact with an opposite edge of the object;
a plurality of locking plates each including an upper portion defining an aperture for receiving the rod and a lower portion extending from the upper portion at an angle, wherein the apertures are sized so that the locking plates easily slide on the rod whenever the upper portions thereof are normal to the rod but lock to the rod whenever the upper portions thereof are tipped from the normal position as the upper portions of the locking plates are moved by means of the rod while the lower portions of the locking plates are stopped by means of the movable jaw;
a release carrier movable relative to the movable jaw; and
a spring compressed between the movable jaw and the locking plates for returning the upper portions of the locking plates to the normal position; and
a cam pivotally connected with the rod for contact with the stationary jaw so that pivotal of the lever and the contact of the cam with the stationary jaw cause movement of the rod along the body.

2. The guide clamp according to claim 1 further including a lever extending from the cam for easy rotation of the cam.

3. The guide clamp according to claim 1 wherein the movable jaw includes a first end, a second end, a bottom, a top, two walls and a recess defined in the top, and the release carrier includes a connector extending through the recess of the movable jaw and including an enlarged end for abutting the movable jaw the release carrier.

4. The guide clamp according to claim 1 further including an end cap secured to the body for keeping the movable jaw assembly to the body.

5. The guide clamp according to claim 1 wherein the body includes two individual members that are connected with each other.

6. The guide clamp according to claim 5 further including a connecting device for connecting the individual members of the body with each other.

7. The guide clamp according to claim 6 wherein each of the individual members of the body defines a dovetail groove, and the locking device includes a dovetail including two sections each inserted in the dovetail groove of one of the bodies and two screw each driven into each of the bodies through one of the sections of the dovetail.

8. The guide clamp according to claim 7 wherein each of the sections of the dovetail defines an aperture through which one of the screws is driven.

9. A guide clamp set including two guide clamps according to claim 1.

10. The guide clamp set according to claim 9 including a connecting device for connecting the guide clamps with each other.

11. The guide clamp set according to claim 10 wherein the body of each of the guide clamps defines a groove, and the connecting device includes:
a connecting plate including two claws put in the groove of the body of each of the guide clamps;
a washer; and
a screw driven into the connecting plate through the washer.

12. The guide clamp set according to claim 11 wherein the connecting plate defines an aperture for receiving the screw.

13. A guide clamp including:
a body including a first face for contact with an object and a second face defining a groove including an open end for receiving a fastening element, a bottom and a reduced top for trapping the fastening element;
a stationary jaw secured to the body for contact with an edge of the object;
a movable jaw assembly movable along the body, the movable jaw assembly including:
a movable jaw for contact with an opposite edge of the object;
a plurality of locking plates each including an upper portion defining an aperture for receiving the rod and a lower portion extending from the upper portion at an angle, wherein the apertures are sized so that the locking plates easily slide on the rod whenever the upper portions thereof are normal to the rod but lock to the rod whenever the upper portions thereof are tipped from the normal position as the upper portions of the locking plates are moved by means of the rod while the lower portions of the locking plates are stopped by means of the movable jaw; and
a release carrier movable relative to the movable jaw; and
a cam pivotally connected with the rod for contact with the stationary jaw so that pivotal of the lever and the contact of the cam with the stationary jaw cause movement of the rod along the body.

14. The guide clamp according to claim 13 wherein the body includes two individual members that are connected with each other.

15. The guide clamp according to claim 14 further including a connecting device for connecting the individual members of the body with each other.

16. The guide clamp according to claim 15 wherein the groove of each of the individual members of the body is a dovetail groove, and the locking device includes a dovetail including two sections each inserted in the dovetail groove of one of the bodies and two screw each driven into each of the bodies through one of the sections of the dovetail.

17. The guide clamp according to claim 16 wherein each of the sections of the dovetail defines an aperture through which one of the screws is driven.

18. A guide clamp set including two guide clamps according to claim 13.

19. The guide clamp set according to claim 18 including a connecting device for connecting the guide clamps with each other.

20. The guide clamp set according to claim 19 wherein the body of each of the guide clamps defines a groove, and the connecting device includes:
a connecting plate including two claws put in the groove of the body of each of the guide clamps;
a washer; and
a screw driven into the connecting plate through the washer.
